(19) United States
(12) Patent Application Publication
(10) Pub. No.: US 2023/0390676 A1
(43) Pub. Date: Dec. 7, 2023

(54) Liquid Filter with a Clean-Side Stop Valve as well as an Assembly with a Liquid Filter and a Liquid Circuit

(71) Applicant: MANN+HUMMEL GmbH, Ludwigsburg (DE)

(72) Inventor: Christian VOGT, Ludwigsburg (DE)

(21) Appl. No.: 18/328,831

(22) Filed: Jun. 5, 2023

(30) Foreign Application Priority Data
Jun. 7, 2022 (DE) 102022114309.0

(51) Int. Cl. B01D 35/153; B01D 29/96

(52) U.S. Cl. CPC B01D 35/153; B01D 29/96; B01D 2201/306; B01D 2201/167

(57) ABSTRACT

A liquid filter for detachable arrangement at a liquid circuit has a filter bellows and an outlet opening at the clean side. A stop valve downstream of the filter bellows closes the outlet opening in an unmounted state of the liquid filter. The stop valve is opened mechanically by a discharge socket of the liquid circuit in a mounted state of the liquid filter. An assembly with liquid circuit and liquid filter detachably arranged at the liquid circuit is provided. The liquid filter has a filter bellows, an outlet opening at the clean side, and a stop valve downstream of the filter bellows closing the outlet opening in an unmounted state of the liquid filter, wherein a discharge socket of the liquid circuit connects to the clean side and actuates and opens mechanically the stop valve of the liquid filter in the mounted state of the liquid filter.

### CROSS-REFERENCE TO RELATED APPLICATION

This application claims a priority date of 7-Jun.-2022 based on prior filed German patent application No. 102022114309.0, the entire contents of the aforesaid German patent application being incorporated herein by reference to the fullest extent permitted by the law.

### BACKGROUND OF THE INVENTION

The invention concerns a liquid filter for detachable arrangement at a liquid circuit. Furthermore, the invention concerns an assembly of a liquid filter arranged at a liquid circuit. The liquid is, for example, motor oil for internal combustion engines or a liquid for electric drives, for example, coolant, in particular cooling oil, transmission oil or hydraulic oil.

Such liquid filters are used for the filtration of the liquid flowing in the liquid circuit. The filter element of the liquid filter divides the liquid filter in this context into a raw side upstream of the filter element in flow direction and containing unfiltered liquid and a clean side downstream of the filter element in flow direction and containing the filtered liquid. During operation, the filter element becomes clogged over time by foreign bodies filtered out of the liquid for which reason the filter element, after a given time, must be exchanged in order to reinstate the function of the liquid filter.

When exchanging the filter element or the liquid filter, it must be demounted from the liquid circuit, whereby a significant quantity of liquid can escape from the liquid filter.

Conventional liquid filters comprise often a raw-side nonreturn device which prevents—opposite to the flow direction provided in operation—an escape of liquid. However, the nonreturn device cannot prevent an escape of liquid at the clean side of the liquid filter.

In order to prevent an escape of liquid via the clean side of the liquid filter, liquid filters comprise often a clean-side fluid-mechanical check valve. While the liquid filter is in operation, the check valve is opened by the liquid pressure in the interior of the liquid filter in flow direction so that a flow through the liquid filter is possible. When the liquid filter is inoperative, for example, during exchange of the liquid filter, the check valve is closed due to the low inner pressure of the liquid filter. In this way, an escape of liquid via the clean side can be prevented when demounting the liquid filter.

However, in this context the fluid-mechanical check valve causes a significant pressure loss of the liquid filter in operation of the liquid filter so that an increased supply pressure in the liquid circuit is required.

### SUMMARY OF THE INVENTION

It is the object of the invention to propose a liquid filter which prevents the escape of liquid from the liquid filter when demounting the liquid filter and, in addition, causes a minimal pressure loss in operation.

This object is solved according to the invention by a liquid filter for detachable arrangement at a liquid circuit, comprising a stop valve arranged downstream of a filter bellows, wherein the stop valve closes a clean-side outlet opening of the liquid filter in an unmounted state of the liquid filter, and wherein the stop valve is openable mechanically by a discharge socket of the liquid circuit in the mounted state of the liquid filter.

This object is further solved according to the invention by an assembly comprising a liquid circuit and a liquid filter according to the invention arranged at the liquid circuit, wherein the liquid circuit comprises a discharge socket for clean-side connection of the liquid filter, and wherein the stop valve of the liquid filter is mechanically actuated by the discharge socket.

In other words, the object is solved by a liquid filter for detachable arrangement at a liquid circuit, comprising a stop valve arranged downstream of the filter bellows, wherein the stop valve closes off a clean-side outlet opening of the liquid filter in an unmounted state of the liquid filter, and wherein the stop valve is openable mechanically by a discharge socket of the liquid circuit in the mounted state of the liquid filter. The stop valve comprises thus an opening direction which is oriented opposite to a flow direction through the liquid filter.

The liquid filter according to the invention is in particular provided for liquids such as fuels, in particular gasoline or diesel, and/or oils, in particular motor oils. The use of such liquids requires particular care in a servicing situation in order to counteract environmental contamination. Furthermore, these liquids, in particular at low temperatures, comprise at times high viscosities so that the afore described pressure losses at the liquid filter can be particularly high.

The liquid filter according to the invention can be arranged at a liquid circuit, for example, a fuel and/or motor oil circuit of an internal combustion engine.

The liquid filter according to the invention comprises a stop valve which is closed in the demounted state and is permanently open in the mounted state. In other words, opening and closing of the stop valve is independent of the pressure of the liquid in the interior of the liquid filter.

The stop valve is mechanically actuatable by the discharge socket of the liquid circuit, i.e., can be opened and closed. During mounting of the liquid filter, the discharge socket of the liquid circuit actuates the stop valve so that the latter is kept in an open position due to the discharge socket. When the liquid filter is demounted, the actuation of the stop valve is canceled so that the latter changes into a closed position. This results in a plurality of advantages. In other words, the stop valve comprises a geometric overlap region with the discharge socket of the liquid circuit. When the liquid filter is mounted at the liquid circuit, the discharge socket displaces the stop valve, wherein the discharge socket is in constant contact with the stop valve.

When demounting the liquid filter, for example, in the servicing situation, the stop valve is closed so that no liquid can escape via the clean side of the liquid filter. In this way, demounting or the exchange of the liquid filter can be realized in a particular clean manner. In particular in connection with a raw-side nonreturn device, an escape of liquid from the liquid filter can be prevented particularly reliably. This goes easy on the environment.

A further advantage of the liquid filter according to the invention resides in that upon mounting, for example, when screwing on, the stop valve is permanently opened by the discharge socket of the liquid circuit. In this way, the pressure loss which is produced in conventional filters by opening the check valve can be avoided and the absolute pressure loss across the liquid filter can be reduced.

In a preferred embodiment of the liquid filter, the stop valve has a stop element for closing the outlet opening. The stop element can be embodied, for example, as a ball, a plate, or as a piston.

Preferably, the stop element is substantially embodied as a piston, in particular as a hollow profile, and comprises a hollow profile section. Further preferred, the stop element comprises at least one cutout which is formed in the wall of the hollow profile section and which, in a mounted state of the liquid filter, forms a clean oil-side passage opening into the liquid circuit. In other words, the at least one cutout in an open state of the stop valve is embodied as a passage opening for the filtered liquid from the liquid filter into the liquid circuit. Particularly preferred, the hollow profile section comprises a plurality of cutouts which, in a mounted state of the liquid filter, form clean-side passage openings. In this way, the pressure loss of the liquid filter can be further reduced.

The stop element is preferably arranged in such a way at the stop valve that the wall of the hollow profile section extends in the opening or closing direction of the stop valve. In other words, the at least one cutout has an opening axis which is embodied at a slant, in particular at a right angle, to the opening or closing direction of the stop valve.

In a particular embodiment, the stop element is embodied as a cylinder and comprises at least one hollow cylinder section wherein the at least one cutout is formed in the wall of the at least one hollow cylinder section.

A further embodiment of the liquid filter is preferred in which a flow cross section of the stop element, in particular of the hollow profile section, corresponds to a flow cross section of the discharge socket of the liquid circuit. Preferably, an inner diameter of the hollow cylinder section equals an inner diameter of the discharge socket. In the mounted state of the liquid filter, the stop element, in particular the hollow cylinder section, can form together with the discharge socket of the liquid circuit a clean-side flow channel. In this way, a particularly seal-tight coupling with the liquid circuit can be realized.

An embodiment of the liquid filter is further preferred in which the stop element in an unmounted state of the liquid filter is pushed by means of a tensioning element against a valve seat of the stop valve. Preferably, the tensioning element is embodied as a spring, in particular as a coil spring.

In a further preferred embodiment of the liquid filter, it can be provided that the stop element comprises a projection projecting past the valve seat. The projection can be embodied opposite to an opening direction of the stop valve, in particular so as to extend axially. In this way, a particularly safe seat of the stop element at the valve seat can be realized.

Preferably, the projection rests seal-tightly at a radial seal ring which separates the clean side from the raw side in a mounted state of the liquid filter. In this manner, it can be prevented that unfiltered liquid passes from the raw side to the clean side. Preferably, the discharge socket displaces the stop element upon mounting of the liquid filter in such a way that the discharge socket subsequently rests seal-tightly at the radial seal ring. In this way, the use of a further sealing element is obsolete.

As an alternative, it is conceivable that in the region of the valve seat a shaped seal is arranged at which the stop element rests radially and/or axially in a seal-tight manner.

Further preferred is an embodiment of the liquid filter in which the liquid filter is embodied with axial symmetry and wherein the stop element is arranged coaxially to a center axis of the liquid filter. In other words, the stop valve can be arranged centrally at the liquid filter.

In a preferred further embodiment of the liquid filter, it is provided that the stop valve comprises in addition a support element and a spring element, wherein the spring element with one end is supported at the support element and with the other end at the stop element, and wherein the stop element is locked captively at the support element. In other words, the stop element, the support element as well as the spring element form a construction unit. In this way, the joining process of the liquid filter can be simplified. In addition, the stop valve can be retrofitted in a particularly simple manner.

The stop valve can be arranged detachably at the liquid filter. In this way, existing liquid filters can be retrofitted particularly easily. After exchange of the filter bellows, the stop valve can be further advantageously reinserted into the new liquid filter or can be reused.

In a preferred embodiment of the liquid filter, the liquid filter comprises a bayonet closure or a thread closure for mounting at the liquid circuit. In this way, the liquid filter can be particularly quickly and simply arranged at the liquid circuit.

Further preferred is an embodiment of the liquid filter in which the stop valve is arranged inside the liquid filter between an end disk of the liquid filter framing the filter bellows and the filter bellows of the liquid filter. In other words, the stop valve can be arranged so as to be clamped between the end disk and the filter bellows in the liquid filter. In this way, the stop valve can be arranged particularly easily within the liquid filter without additional fastening means.

Preferred is an embodiment of the liquid filter in which the support element forms at least partially an end disk framing the filter bellows. In this way, the manufacture of the liquid filter can be simplified by a reduced number of individual components.

The underlying object is furthermore solved by an assembly comprising a liquid circuit and a liquid filter as described beforehand and arranged at the liquid circuit, wherein the liquid circuit comprises the discharge socket for clean-side connection of the liquid filter, and wherein the stop valve of the liquid filter is mechanically actuated by the discharge socket.

In other words, the liquid filter is arranged at the liquid circuit, wherein the stop valve is displaced by the discharge socket and is held by the latter in an open position.

In a preferred embodiment of the assembly in combination with the afore described radial seal ring, it can be provided that the discharge socket rests seal-tightly at the radial seal ring. In this way, a further advantageous effect results. The radial seal ring seals the raw side in relation to the clean side of the liquid filter in an unmounted state of the liquid filter and ensures moreover that no liquid can escape into the environment. When the liquid filter is mounted at the liquid circuit, the discharge socket displaces the stop valve and assumes the position of the stop valve at the radial seal ring. In other words, the radial seal ring according to this embodiment can ensure the sealing action in the unmounted state as well as in the mounted state of the liquid filter.

Further advantages of the invention result from the description, the claims, and the drawing. Also, the aforementioned and still to be explained features according to the invention can be used individually by themselves or several of them in arbitrary expedient combinations. The illustrated and described embodiments are not to be understood as a complete list but rather have an exemplary character for describing the invention.

### BRIEF DESCRIPTION OF THE DRAWING

FIG. 1 shows a first embodiment of a liquid filter with a stop valve in unmounted state in a sectioned side view.

FIG. 2 shows a first assembly with the first embodiment of the liquid filter of FIG. 1 in a mounted state at a liquid circuit in a sectioned side view.

FIG. 3 shows a second embodiment of a liquid filter with a stop valve in the unmounted state in a sectioned side view.

FIG. 4 shows a second assembly with the second embodiment of the liquid filter of FIG. 3 in a mounted state at a liquid circuit in a sectioned side view.

### DESCRIPTION OF PREFERRED EMBODIMENTS

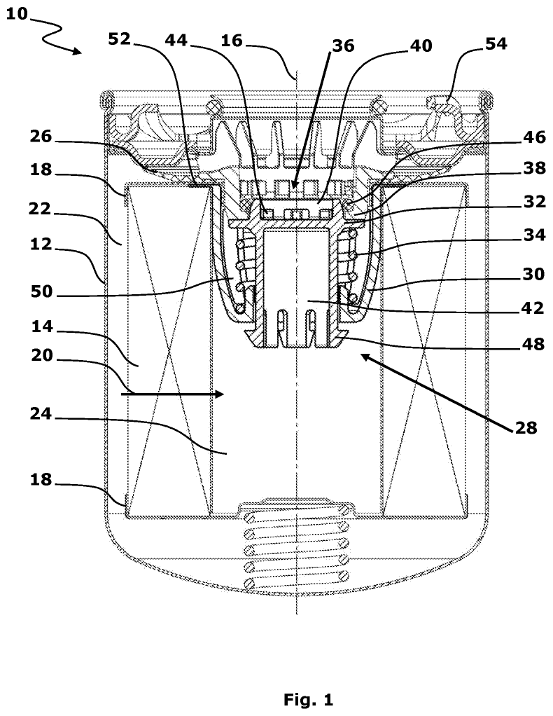

FIG. 1 shows a liquid filter 10 with a housing 12 and a filter bellows 14. The liquid filter 10 comprises a center axis 16. The liquid filter 10 can be of axial symmetry in relation to the center axis 16.

The filter bellows 14 according to the illustrated embodiment is of a hollow cylindrical configuration and is arranged framed between two end disks 18 in the liquid filter 10. In operation of the liquid filter 10, it is provided that the filter bellows 14 is flowed through substantially in a radially inwardly oriented filtration direction 20. In other words, the filter bellows 14 is flowed through by the fluid to be filtered (not illustrated) from the exterior to the interior, wherein the filter bellows 14, depending on the type, can comprise local deviations from the filtration direction 20. The liquid filter 10 comprises a raw side 22 with unfiltered liquid and a clean side 24 with filtered liquid.

According to the illustrated embodiment, the liquid filter 10 comprises a pressure-controlled nonreturn device 26. The nonreturn device 26 opens in case the differential pressure between the pressure in front of the nonreturn device 26 and the pressure behind the nonreturn device 26 reaches a predetermined value. When the liquid filter 10 is not in operation, the nonreturn device 26 is closed and the escape of liquid through the nonreturn device 26 is prevented.

The liquid filter 10 comprises a stop valve 28 that is arranged at the clean side 24 of the liquid filter 10. According to the illustrated embodiment, the stop valve 28 is surrounded completely by the filter bellows 14. In other words, the stop valve 28 is arranged completely inside the filter bellows 14. In this way, the liquid filter 10 can be designed particularly compact.

The stop valve 28 comprises a support element 30, a stop element 32 as well as a spring element 34. The stop valve 28 closes—as illustrated—an outlet opening 36 of the liquid filter 10.

The spring element 34 is arranged between the support element 30 and the stop element 32 and causes the stop element 32 to be pressed against a valve seat 38 of the liquid filter 10. The stop valve 28 or the stop element 32 can be manufactured of a sealing material or comprise a sealing material in the contact region with the valve seat 38.

In accordance with the embodiment, the stop element 32 is configured as a cylinder and comprises a first hollow cylinder section 40 and a second hollow cylinder section 42. The first hollow cylinder section 40 comprises a plurality of cutouts 44 which are formed in the wall of the first hollow cylinder section 40 (for reasons of simplification, only one cutout 44 is provided with a reference character). The first hollow cylinder section 40 projects along the center axis 16 past the valve seat 38.

According to the illustrated embodiment, the liquid filter 10 comprises a radial seal ring 46 which fluid-tightly seals the stop element 32—here the first hollow cylinder section 40—in relation to the outlet opening 36.

The stop element 32 is slidingly arranged at the support element 30. In other words, the support element 30 guides the stop element 32 in an opening or closing direction of the stop valve 28 along the center axis 16.

The stop element 32 comprises at the bottom end of the second hollow cylinder section 42 spring clips 48 which engage behind the support element 30 in an assembled state of the stop valve 28. In this way, the stop element 32 can be attached captively, but movably and detachably, at the support element 30.

According to the illustrated embodiment, the support element 30 surrounds the spring element 34 and the stop element 32. In other words, the spring element 34 and the stop element 32 are arranged in the interior of the support element 30. In this way, a compact construction unit can be provided.

The support element 30 is primarily of a cylindrical configuration and comprises cutouts 50 through which the filtered liquid can flow without greater pressure loss. The support element 30 comprises a fastening flange 52 which extends perpendicularly to the center axis 16. The fastening flange 52 is arranged between the filter bellows 14 and the end disk 18. The fastening flange 52 can be glued or welded, for example. In the illustrated embodiment, the fastening flange 52 is arranged so as to be clamped so that the stop valve 28 can be arranged and/or removed particularly easily.

The liquid filter 10 comprises a bayonet closure 54 which enables a particularly simple and fast fastening of the liquid filter 10.

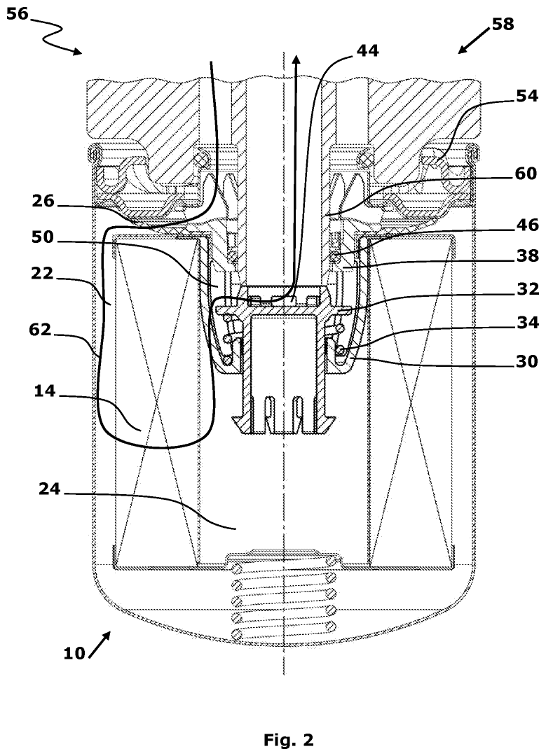

FIG. 2 shows an assembly 56 with the liquid filter 10 of FIG. 1 and a liquid circuit 58. The liquid filter 10 is fastened by means of the bayonet closure 54 detachably at the liquid circuit 58.

A discharge socket 60 of the liquid circuit 58 is in mechanical contact with the stop element 32 of the stop valve 28 so that the latter remains in an open position opposite to the spring force of the spring element 34. In other words, the discharge socket 60 displaces the stop element 32 in the mounted state of the liquid filter 10 at the liquid circuit 58. When the liquid filter 10 is demounted from the liquid circuit 58, the stop element 32 by means of the spring force of the spring element 34 is pressed against the valve seat 38 and closes the liquid filter 10 at the clean side 24.

In FIG. 2, the radial seal ring 46 contacts the discharge socket 60 and seals the clean side 24 in relation to the raw side 22. In this way, it can be effectively prevented that unfiltered liquid from the raw side 22 can pass to the clean side 24. When the liquid filter 10 is demounted, the stop element 32 contacts seal-tightly the radial seal ring 46.

In operation of the liquid filter 10, fluid flows along an exemplary flow path 62 through the pressure-opened nonreturn device 26 from the raw side 22 through the filter bellows 14 to the clean side 24 of the liquid filter 10. In other words, the liquid flowing into the fluid filter 10 is filtered by the filter bellows 14. Subsequently, the filtered fluid flows through the cutouts 50 of the support element 30 as well as through the cutouts 44 of the stop element 32.

While in the mounted state, the cutouts 44 of the stop element 32 are open permanently and are formed as passage openings of the liquid filter 10 toward the liquid circuit 58. Opening of the cutouts 44 by means of the liquid is not required.

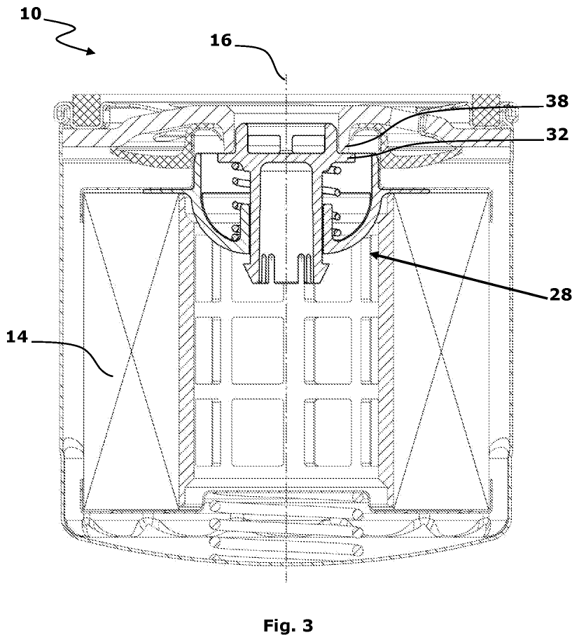

FIG. 3 shows a further embodiment of a liquid filter 10. The liquid filter 10 shown in FIG. 3 differs from the liquid filter 10 illustrated in FIGS. 1 and 2 substantially in that the stop valve 28 projects along the center axis 16 past the filter bellows 14. In other words, the stop valve 28 is not completely arranged inside of the filter bellows 14. This enables the adaptation of the liquid filter 10 to a discharge socket 60 (see FIG. 2) with reduced length. Thus, the liquid filter 10 can be adapted in a particularly easy manner to different liquid circuits 58.

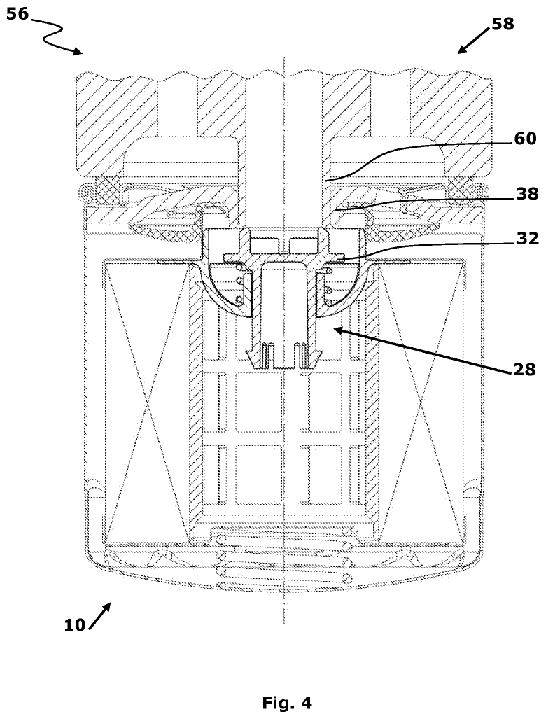

FIG. 4 shows the liquid filter 10 of FIG. 3 in a second assembly 56 with a liquid circuit 58. The liquid circuit 58 comprises a shortened discharge socket 60. According to the illustration, the liquid filter 10 is in a mounted state at the liquid circuit 58. The discharge socket 60 is in mechanical contact with the stop element 32 of the stop valve 28 and holds it in an open state.

The discharge socket 60 rests seal-tightly at the valve seat 38. For this purpose, the valve seat 38 can comprise or be comprised of a sealing material. Furthermore, it can be provided that the discharge socket 60 itself comprises or is comprised of a sealing material. Alternatively or additionally, it can be provided that the discharge socket 60 and the valve seat 38 form a fluid-tight press fit.

### LIST OF REFERENCE CHARACTERS

10 liquid filter

12 housing of the liquid filter 10

14 filter bellows of the liquid filter 10

16 center axis

18 end disk

20 filter device

22 raw side

24 clean side

26 nonreturn device

28 stop valve

30 support element of the stop valve 28

32 stop element of the stop valve 28

34 spring element of the stop valve 28

36 outlet opening of the liquid filter 10

38 valve seat of the liquid filter 10

40 first hollow cylinder section

42 second hollow cylinder section

44 cutouts in the first hollow cylinder section 40

46 radial seal ring

48 spring clip

50 cutout in the support element 30

52 fastening flange of the support element 30

54 bayonet closure

56 assembly

58 liquid circuit

60 discharge socket of the liquid circuit 58

62 flow path

What is claimed is:

1. A liquid filter for detachable arrangement at a liquid circuit, the liquid filter comprising:
a filter bellows;
an outlet opening arranged at a clean side of the liquid filter;
a stop valve arranged downstream of the filter bellows, wherein the stop valve closes the outlet opening in an unmounted state of the liquid filter, and wherein the stop valve is configured to be opened mechanically by a discharge socket of the liquid circuit in a mounted state of the liquid filter at the liquid circuit.

2. The liquid filter according to claim 1, wherein the stop valve comprises a stop element closing the outlet opening in the unmounted state of the liquid filter, wherein the stop element comprises a wall and at least one cutout formed in the wall, wherein the at least one cutout forms a passage opening, arranged at the clean side of the liquid filter, in the mounted state of the liquid filter at the liquid circuit.

3. The liquid filter according to claim 2, wherein an inner diameter of the stop element corresponds to an inner diameter of the discharge socket of the liquid circuit.

4. The liquid filter according to claim 2, wherein the stop valve comprises a tensioning element pushing the stop element in the unmounted state of the liquid filter against a valve seat of the stop valve.

5. The liquid filter according to claim 4, wherein the stop element comprises a projection projecting past the valve seat of the stop valve in a direction along a center axis of the liquid filter, wherein the projection rests seal-tightly at a radial seal ring of the liquid filter in the unmounted state of the liquid filter, wherein the radial seal ring separates the clean side of the liquid filter from a raw side of the liquid filter in the mounted state of the liquid filter at the liquid circuit.

6. The liquid filter according to claim 4, wherein the valve seat of the stop valve comprises a shaped seal, and wherein the stop element rests radially and/or axially seal-tightly at the shaped seal in the unmounted state of the liquid filter.

7. The liquid filter according to claim 2, wherein the stop valve further comprises a support element and a spring element, wherein the spring element has a first end supported at the support element and has a second end supported at the stop element, and wherein the stop element is locked captively at the support element.

8. The liquid filter according to claim 7, wherein the support element forms at least partially an end disk framing the filter bellows.

9. The liquid filter according to claim 1, wherein the liquid filter comprises a center axis and is of axial symmetry in relation to the center axis, and wherein the stop valve is arranged coaxially to the center axis of the liquid filter.

10. The liquid filter according to claim 1, further comprising a bayonet closure configured to mount the liquid filter at the liquid circuit or a thread closure configured to mount the liquid filter at the liquid circuit.

11. The liquid filter according to claim 1, further comprising an end disk framing the filter bellows, wherein the stop valve is arranged inside the liquid filter between the filter bellows and the end disk framing the filter bellows.

12. The liquid filter according to claim 11, wherein the stop valve comprises a support element forming at least partially the end disk framing the filter bellows.

13. An assembly comprising:
a liquid circuit;
a liquid filter detachably arranged at the liquid circuit, the liquid filter comprising a filter bellows, an outlet opening arranged at a clean side of the liquid filter, and a stop valve arranged downstream of the filter bellows, wherein the stop valve closes the outlet opening in an unmounted state of the liquid filter;
wherein the liquid circuit comprises a discharge socket configured to connect to the clean side of the liquid filter;
wherein the stop valve of the liquid filter is configured to be actuated and opened mechanically by the discharge socket of the liquid circuit in a mounted state of the liquid filter at the liquid circuit.

14. The assembly according to claim 13, wherein the stop valve of the liquid filter comprises a valve seat and a stop element comprising a projection projecting past the valve seat of the stop valve of the liquid filter in a direction along a center axis of the liquid filter, wherein the projection rests seal-tightly at a radial seal ring of the liquid filter in the unmounted state of the liquid filter, wherein the radial seal ring separates the clean side of the liquid filter from a raw side of the liquid filter in the mounted state of the liquid filter at the liquid circuit, wherein the discharge socket rests seal-tightly at the radial seal ring in the mounted state of the liquid filter at the liquid circuit. The assembly according to claim 13, wherein the stop valve of the liquid filter comprises a valve seat comprising a shaped seal and further comprises a stop element, wherein the stop element of the stop valve rests radially and/or axially seal-tightly at the shaped seal in the unmounted state of the liquid filter, wherein the discharge socket seal-tightly rests at the shaped seal in the mounted state of the liquid filter at the liquid circuit.
